(19) United States
(12) Patent Application Publication
(10) Pub. No.: US 2016/0225065 A1
(43) Pub. Date: Aug. 4, 2016

(54) UNIVERSAL BUSINESS PROCUREMENT

(71) Applicant: Amazon Technologies, Inc., Seattle, WA (US)

(72) Inventors: Murali Govindaswamy, Seattle, WA (US); Saiprasad Kapila, Seattle, WA (US); John Michael Hall, DuPont, WA (US)

(21) Appl. No.: 14/612,457

(22) Filed: Feb. 3, 2015

(51) Int. Cl. G06Q 30/06

(52) U.S. Cl. CPC G06Q 30/0635

(57) ABSTRACT

Various methods and techniques are described for providing the ability to make purchases from a number of network-based retailers while enforcing a common set of policy policies. A user submits a request to progress a transaction involving one or more items available from an electronic marketplace. A set of procurement policies may be associated with an account for the user. From that set of procurement policies, a procurement policy may be found that is applicable to the transaction. This procurement policy is then applied to the transaction.

### BACKGROUND

With the growing use of the Internet, electronic retailers have made vast improvements in their inventory control methods, item availability, and shipping practices. These improvements by network-based retailers have allowed them to create efficient and inexpensive methods of providing items (e.g., goods and/or services) to consumers. However, despite this trend, businesses often have procurement policies in place that prevent them from purchasing from many network-based retailers at the business or enterprise level, which results in an inability to take advantage of these improvements in managing inventory control for, availability of and shipping of items.

### BRIEF DESCRIPTION OF THE DRAWINGS

Various embodiments in accordance with the present disclosure will be described with reference to the drawings, in which:

FIG. 1 is a use case diagram depicting aspects of a universal procurement system in accordance with at least one embodiment;

FIG. 2 is a schematic diagram depicting aspects of an example architecture for implementing the universal procurement system in accordance with at least one embodiment;

FIG. 3 is a data flow diagram depicting aspects of an example procurement enforcement provided in the universal procurement system in accordance with at least one embodiment;

FIG. 4 is a use case diagram depicting aspects of an example user interaction with the universal procurement system in accordance with at least one embodiment;

FIG. 5 is a user interface diagram depicting aspects of an example item selection in the universal procurement system accordance with at least one embodiment;

FIG. 6 is a flowchart depicting aspects of an example method for implementing procurement policies in the universal procurement system in accordance with at least one embodiment;

FIG. 7 is a flowchart depicting aspects of an example method for completing a purchase transaction in the universal procurement system in accordance with at least one embodiment; and

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein include providing a user with a means of enforcing consistent procurement policies across a multitude of network retail sites using a universal procurement system. Specifically, the current disclosure is directed to enforcing procurement policies with electronic marketplaces.

In accordance with at least one embodiment, a user is provided with the ability to make purchases from a number of network retail sites while enforcing a common set of procurement policies. A user may be any suitable person or entity acting on behalf of, or with authority from, a business establishment or other entity to make purchases. In accordance with at least one embodiment, a user may be a member or representative of the business establishment or entity, such as a procurement agent or buyer for the business establishment. In accordance with at least one embodiment, the user may be an employee or contractor of the entity that is authorized to purchase supplies or materials. In accordance with at least one embodiment, the user may be required to log in to an account maintained by a service provider providing the universal procurement system in order to make purchases on behalf of the entity.

In accordance with at least one embodiment, a network site extension (or plugin) may be used to enhance or augment a browser utilized on a user's computing device. This network site extension may allow a user to select an item that is typically available for purchase on a network retail site and purchase the selected item using a checkout interface that is provided by the service provider. In accordance with at least one embodiment, the network site extension stores information in an network cookie, or links to network pages that describe items available for purchase (e.g., “item pages”), for later purchase via the service provider. In accordance with at least one embodiment, the service provider may maintain a relationship with the network retail site, such as an affiliated network retail site. In accordance with at least one embodiment, the network retail site may be unaffiliated with the service provider.

The user may represent a business or other entity that has established procurement policies. In accordance with at least one embodiment, the procurement policies are stored in a data store that is maintained by the service provider. Procurement policies (which include procurement rules and procurement workflows) may be applied to user purchases based on the business entity, the user, the method of payment, the type of item, and/or a number of other suitable factors. Once applied, a procurement policy may determine whether and/or under what conditions the item may be procured for the entity as requested. For example, a procurement policy may set forth a maximum or minimum order amount, the type of payment method that must be used, an authorization needed prior to ordering, the categories of item that may be ordered by a particular user (e.g., office supplies), or a number of restrictions. For example, an order made by a particular user that is over a given dollar amount may be presented to the user's manager for approval prior to the order being placed. By way of further example, a procurement policy may require that any purchase made by a particular user be placed on a company credit card. In accordance with at least one embodiment, the service provider may place an order with a third party network retail site on behalf of the user.

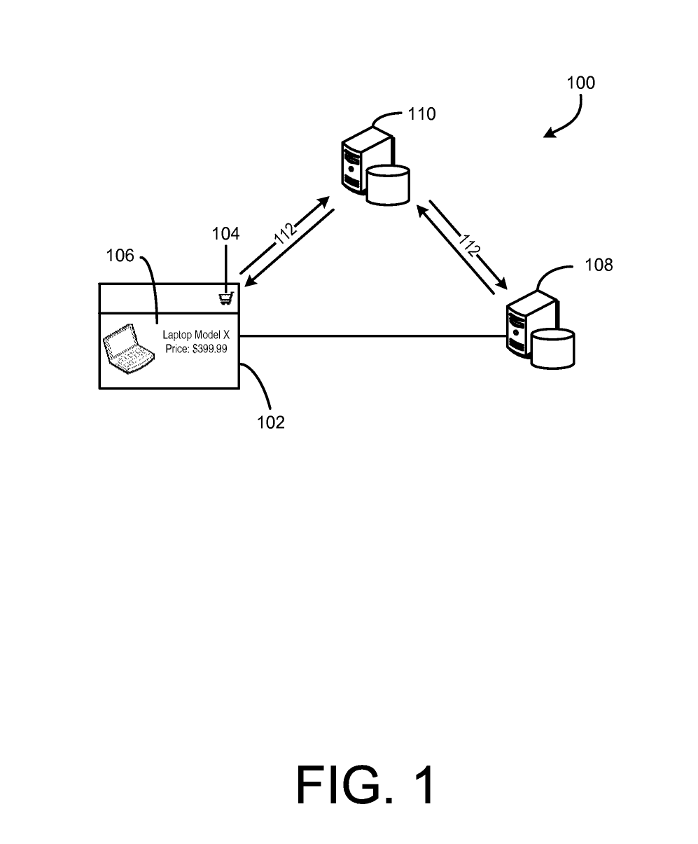

FIG. 1 is a use case diagram depicting aspects of a universal procurement system 100 in accordance with at least one embodiment. In this illustrative example, a browser 102 is depicted as containing an icon indicating that a network site extension (or plugin) 104 is active. The browser 102 in this example is displaying an item page 106. An item page 106 may be maintained by a network retail site 108 (a provider of an item) that may or may not be affiliated with a service provider 110. In accordance with at least one embodiment, the item page 106 may contain information related to an item offering. An item offering may include any suitable offer to sell an item (any suitable good or service, including digital goods) to a consumer. Information related to the item offering may include price, shipping time, availability, and/or any other suitable item information. The browser 102 may send data to or receive data from the service provider 110 via a network connection 112. Similarly, the service provider 110 may send data to or receive data from the network retail site 108 via a network connection 114. Network site extension 104 may be used to provide policy procurement functionality that is enforced by the service provider 110. Although the embodiment in this illustrative example depicts a network site extension 104 being used to implement functionality provided by the service provider 110, it is envisioned that this functionality may be implemented in a number of other ways. For example, in accordance with at least one embodiment, a user may access the item page 106 through a portal provided by the service provider 110. In accordance with at least one embodiment, procurement policies may be enforced by the provider of the payment method being used, so that the provider of the payment method also acts as the service provider 110. For example, a credit card company may act as the service provider 110 by enforcing procurement policies prior to authorizing a payment and placing an order.

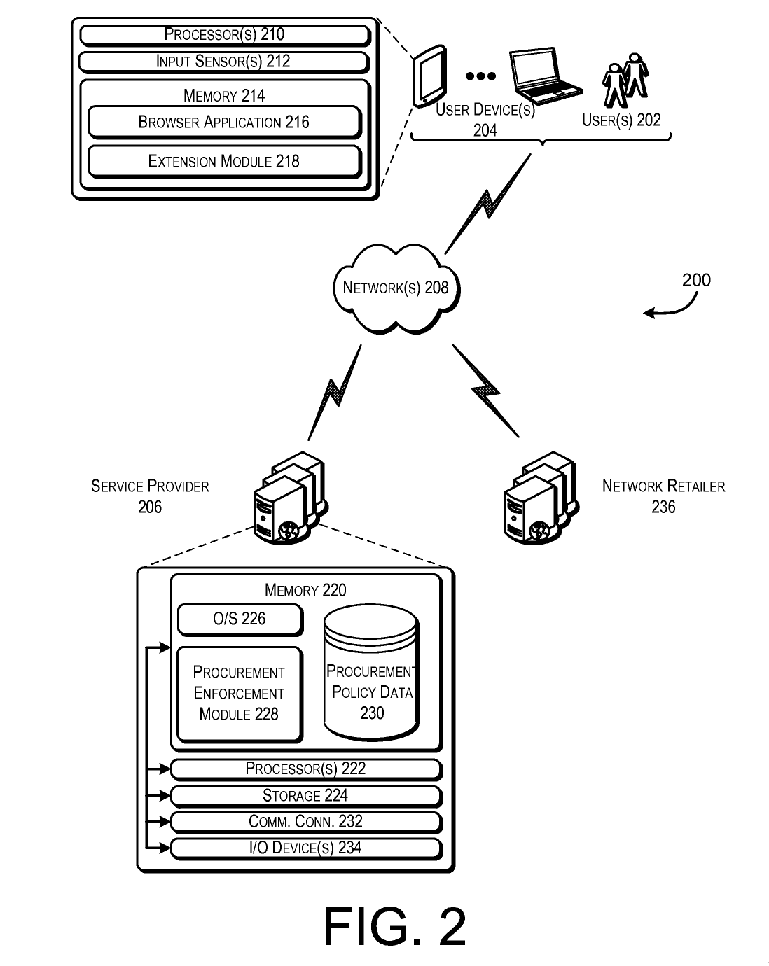

FIG. 2 is a schematic diagram depicting aspects of an example architecture 200 in accordance with at least one embodiment in which techniques for enforcing consistent procurement policies across a multitude of network-based retailers and retail sites may be implemented. In architecture 200, one or more consumers and/or users 202 may utilize a user device 204. In some examples, the user device 204 may be in communication with a service provider 206 via the network(s) 208, or via other network connections.

The user device 204 may be any suitable type of computing device such as, but not limited to, a mobile phone, a smart phone, a personal digital assistant (PDA), a laptop computer, a desktop computer, a server computer, a thin-client device, or a tablet PC. Additionally, a user device 204 may be a watch, earpiece, glasses, or any suitable type of wearable technology device. The user device 204 may include one or more processors 210 capable of processing user input. The user device 204 may also include one or more input sensors 212 for receiving user input. As is known in the art, there are a variety of input sensors 212 capable of detecting user input, such as keypads, touchscreens, accelerometers, cameras, microphones, or any suitable type of sensor device. The user input obtained by the input sensors may be from a variety of data input types, including, but not limited to, audio data, visual data, or biometric data. In accordance with at least one embodiment, the application on the user device 204 may be stored and executed from its memory 214.

Turning to the contents of the memory 214 in more detail, the memory 214 may include a browser application 216. The memory 214 may also include an extension module 218 to extend capabilities to the browser application 216 to allow the service provider 206 to enforce procurement protocols. Although sample architecture 200 depicts an extension module 218 as being included in the contents of the memory 214 of the user device 204, in accordance with at least one embodiment, the user device 204 may not include an extension module 218 in memory 214 of the user device 204. When the extension module 218 is not included in memory 214, the capabilities described with regard to the extension module 218 may instead be provided by the service provider 206. This will be described in more detail below.

In accordance with at least one embodiment, the extension module 218 may be configured to extend capabilities to the browser application 216 in order to allow the service provider 206 to enforce procurement protocols. In accordance with at least one embodiment, the extension module 218 may provide a user 202 with the ability to select an item offering (such as a good or service) from a third party network retail site so that a purchase can be made by the service provider 206. For example, the extension module 218 may be represented by a “shopping cart” icon that allows the user 202 to select items from various network sites and aggregate them for a later purchase. In accordance with at least one embodiment, the extension module 218 may be a plug-in, widget, or browser extension. In accordance with at least one embodiment, extension module 218 may be a separate application that is located on the user device 204.

In some examples, the network(s) 208 may include any one or a combination of many different types of networks, such as cable networks, the Internet, wireless networks, cellular networks, satellite networks, and other private and/or public networks. While the illustrated example represents the users 202 accessing the service provider 206 via the browser application 216 over the network(s) 208, the described techniques may equally apply in instances where the users 202 interact with a service provider 206 via the user device 204 without the use of the browser application 216, such as over a landline phone, via a kiosk, or in any suitable other manner. For example, in embodiments in which the extension module 218 is a separate application from the browser application 216, users 202 may interact with the service provider 206 via the extension module 218. It is also noted that the described techniques may apply in other client/server arrangements (e.g., set-top boxes), as well as in non-client/server arrangements (e.g., locally stored applications, peer to-peer systems, etc.).

As described briefly above, the browser application 216 may allow the users 202 to interact with a service provider 206, such as to store, access, and/or manage data, develop and/or deploy computer applications, and/or host electronic content. The browser application 216 can be any suitable type of client-side application that supports user interaction with a network site. Examples of such network sites include social networking sites, network retail sites, informational sites, blog sites, search engine sites, news and entertainment sites. As discussed above, the described techniques can be implemented outside of the browser application 216, such as with other applications running on the user device 204.

The service provider 206 may include and/or utilize any suitable number and/or type of computing device such as, but not limited to, a mobile phone, a smart phone, a personal digital assistant (PDA), a laptop computer, a desktop computer, a server computer, a thin-client device, and/or a tablet PC. The computing devices of the service provider 206 may be interconnected in any suitable manner to facilitate interoperation (e.g., interconnected communicatively). Alternatively, or in addition, the service provider 206 may be implemented with one more virtual machines implemented in a hosted computing environment. The hosted computing environment may include one or more rapidly provisioned and released computing resources, which computing resources may include computing, networking, and/or storage devices. A hosted computing environment may also be referred to as a cloud-computing environment.

In one illustrative configuration, the service provider 206 may include at least one memory 220 and one or more processing units (or processor(s)) 222. The processor(s) 222 may be implemented as appropriate in hardware, computer-executable instructions, firmware or combinations thereof. Computer-executable instruction or firmware implementations of the processor(s) 222 may include computer-executable or machine executable instructions written in any suitable programming language to perform the various functions described.

The memory 220 may store program instructions that are loadable and executable on the processor(s) 222, as well as data generated during the execution of these programs. Depending on the configuration and type of service provider 206, the memory 220 may be volatile (such as random access memory (RAM)) and/or non-volatile (such as read-only memory (ROM), flash memory). The service provider 206 may also include additional storage 224, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 220 may include multiple different types of memory, such as static random access memory (SRAM), dynamic random access memory (DRAM) or ROM. Turning to the contents of the memory 220 in more detail, the memory 220 may include an operating system 226 and one or more application programs or services for implementing the features disclosed herein including at least a module for enforcing procurement policies across a number of network sites (procurement enforcement module 228). The memory 220 may also include procurement policy data 230, which contains data related to procurement policies/rules. In accordance with at least one embodiment, the procurement policy data 230 may be stored in a database or other data storage schema.

The memory 220 and the additional storage 224, both removable and non-removable, are examples of non-transitory computer-readable storage media. For example, non-transitory computer-readable storage media may include volatile or non-volatile, removable or non-removable media implemented in any suitable method or technology for storage of information such as computer-readable instructions, data structures, program modules or other data. As used herein, modules may refer to programming modules executed by computing systems (e.g., processors) that are part of the user device 204 or the service provider 206. The service provider 206 may also contain communications connection(s) 232 that allow the service provider 206 to communicate with a data store, another computing device or server, user terminals, and/or other devices on the network(s) 208. The service provider 206 may also include input/output (I/O) device(s) and/or ports 234, such as for enabling connection with a keyboard, a mouse, a pen, a voice input device, a touch input device, a display, speakers, a printer, or any suitable external device.

Turning to the contents of the memory 220 in more detail, the memory 220 may include an operating system 226, a database containing procurement policy data 230 and the one or more application programs or services for implementing the features disclosed herein, including a procurement enforcement module 228.

In accordance with at least one embodiment, the procurement enforcement module 228 may be configured to receive data from the extension module 218 and enforce procurement policies across a number of network sites. In accordance with at least one embodiment, the service provider 206 may maintain account information for each user 202, with procurement policy data 230 being associated with each account. An account may be associated with a business establishment or a user-role within that establishment. The service provider 206 may also maintain a business hierarchy with relation to the user 202 account. For example, the service provider 206 may store information indicating that a first user is the manager of a second user. In this example, approval by the first user may be required before a purchase is made by the second user. The user 202 may be required to log in to an account prior to making business-related purchases.

Procurement policy data 230 may be predetermined or it may be dynamically generated. In accordance with at least one embodiment, procurement policy data 230 may contain one or more procurement policy and/or one or more rule sets. In accordance with at least one embodiment, the procurement policy data 230 may include a hierarchy of rules that are associated with a particular account. For example, the procurement policy data 230 may include a procurement rule(s) specific to a business entity, a role within the business entity, a payment method, or a specific user. By way of further example, a user 202 who is a procurement agent of XYZ Corporation may be subjected to a set of rules that governs transactions made by XYZ Corporation employees. In this example, the user 202 may also be subject to a second set of rules that governs transactions made by XYZ Corporation procurement agents. Furthermore, the user 202 may be subject to a third set of rules that governs transactions made using an XYZ Corporation credit card. In this example, each of these rule sets may be associated with the user 202 via an account maintained by the service provider 206.

Procurement policy data 230 may include a variety of procurement rules. Procurement rules may include a designation of a purchasing authority, or elect which items or types of items a user is authorized to purchase. For example, a user with the role of office administrator may be authorized to purchase only items that fall within the item category of office supplies. The category office supplies may be a default item category, or it may be defined by a user with the authorization to create that category. An item category may be identified for an item offering based on the title of the item offering, an item number of the item offering, metadata associated with the item offering, and/or any suitable item information. Procurement rules may include the ability to set a minimum or maximum purchase amount or require signatory authority. For example, a rule may indicate that any purchase over $300 needs management approval. If a user attempts to make such a purchase, the user's manager may be contacted for approval. Procurement rules may automatically populate or set purchase and/or shipping requirements. For example, a business entity may set a rule that requires any item offering purchased using the procurement system to be shipped directly to the business entity's office. In this example, a shipping address may be pre-filled, or automatically populated, and the user may not be given the ability to enter or update the shipping address. Although some examples of procurement rules have been described above, there are many more procurement rules that may be stored in the procurement policy data 230. As such, these examples are intended to be non-limiting.

Alternatively, or in addition to procurement rules, the procurement policy data 230 may include a variety of procurement workflows. In accordance with at least one embodiment, a procurement workflow includes a series of activities (e.g., user-executed and/or computer-executed activities) that are taken in an order to create, progress, update, delete, terminate and/or complete a procurement-related task and/or transaction. In accordance with at least one embodiment, the business entity may be given the ability to create, edit and/or upload a workflow (e.g., a custom workflow). In accordance with at least one embodiment, the business entity (e.g., via an appropriate representative) is able to customize (e.g., alter, remove, and/or add procurement-related activities to) a workflow. The custom workflow may be associated with one or more types of users who are authorized to participate in procurement-related activity on behalf of the business entity. Once established, the service provider 206 may enforce the custom workflow for the specified types of users. In accordance with at least one embodiment, procurement rules set by the business entity may add or remove activities from a workflow when certain conditions are satisfied. For example, a business entity may institute a rule that any purchase over $500 requires additional approval. In accordance with at least one embodiment, an approval (or authorization) activity may be added to a procurement workflow that involves any transaction over $500. In accordance with at least one embodiment, an approval activity may already be a part of the procurement workflow, and it may be removed for a transaction under $500.

Although the procurement enforcement module 228 and procurement policy data 230 are depicted in FIG. 2 as being implemented in the memory 220 of the service provider 206, it is envisioned that one or both of the procurement enforcement module 228 and the procurement policy data 230 could also be implemented in the memory 214 of the user device 204 (such as by extension module 218). In accordance with at least one embodiment, a portion of the enforcement of procurement policies across a number of vendor network sites may be performed at either the service provider 206 by the procurement enforcement module 228 and/or the user device 204 by the extension module 218. It is intended that this disclosure encompass any suitable combination of these implementations.

In accordance with at least one embodiment, the user device 204 may be in communication with at least one network-based retailer 236 via the network(s) 208, or via other network connections. A network-based retailer 236 is an entity that provides at least one item offering. The user 202 may select one or more items available from the network-based retailer 236 that will be ordered via the service provider 206. The network-based retailer 236 may maintain a separate item catalog (such as in a database) with a multitude of item offerings. The network-based retailer 236 may be affiliated with the service provider 206, or it may be an unaffiliated entity. An unaffiliated entity is a business and/or organizational entity that shares no financial or supportive relationship with the service provider 206.

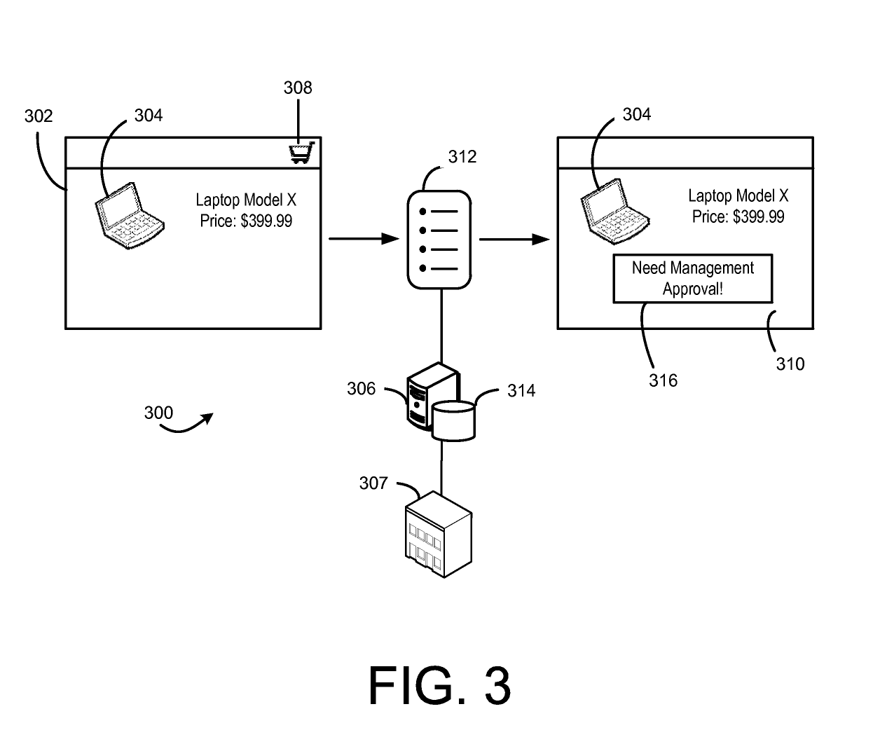

FIG. 3 is a data flow diagram depicting aspects of example procurement enforcement in accordance with at least one embodiment. In illustrative example 300, a browser 302 is displayed, which is being used to view an item offering 304 that is available via network retail site. The network retail site in illustrative example 300 may be affiliated or associated with the service provider 306, or it may be an unaffiliated network retailer. Service provider 306 is an example of service provider 206 of FIG. 2. A business entity 307 may have an account with or may be in communication with service provider 306. In accordance with at least one embodiment, the browser 302 may have had its functionality extended through the use of a browser extension or plug-in. The browser may indicate this additional functionality via the addition of one or more extension icon(s) 308. In accordance with at least one embodiment, a user may be able to interact with the extension icon 308 when the user is viewing an item offering 304 that is available for purchase. An interaction with the extension icon 308 may create or store information in a cookie with an identification of the item offering 304. An interaction with the extension icon 308 may create a request containing a network hyperlink, a network bookmark (a Uniform Resource Identifier (URI) that is stored for later retrieval in any of various storage formats), or a uniform resource identifier with an identification of the item offering 304. In accordance with at least one embodiment, the user may not be able to interact with the extension icon 308, or it may be grayed out, when an item offering is unavailable for purchase or the electronic retailer offering the item is unsupported. In accordance with at least one embodiment, an extension icon 306 may direct a user to a checkout page 310 from which a user can complete a purchase.

In accordance with at least one embodiment, procurement policies 312 may be applied upon an attempt to purchase an item offering 304 by a user. Procurement policies 312 may be provided by business entity 307 and may be stored as rule sets by the service provider 306 in the procurement policy data 314. Procurement policy data 314 is an example procurement policy data 230 of FIG. 2. In accordance with at least one embodiment, procurement policies may be made available to the user. For example, a user may be provided with a procurement enforcement message 316 that indicates an applicable policy. By way of further example, when a maximum price threshold has been exceeded, the user attempting to make the purchase may be notified and the purchase may be prevented. In accordance with at least one embodiment, procurement policies 312 may be enforced without the user's knowledge. For example, the user's manager may be notified, or a spend report may be generated, each time that the user makes a purchase.

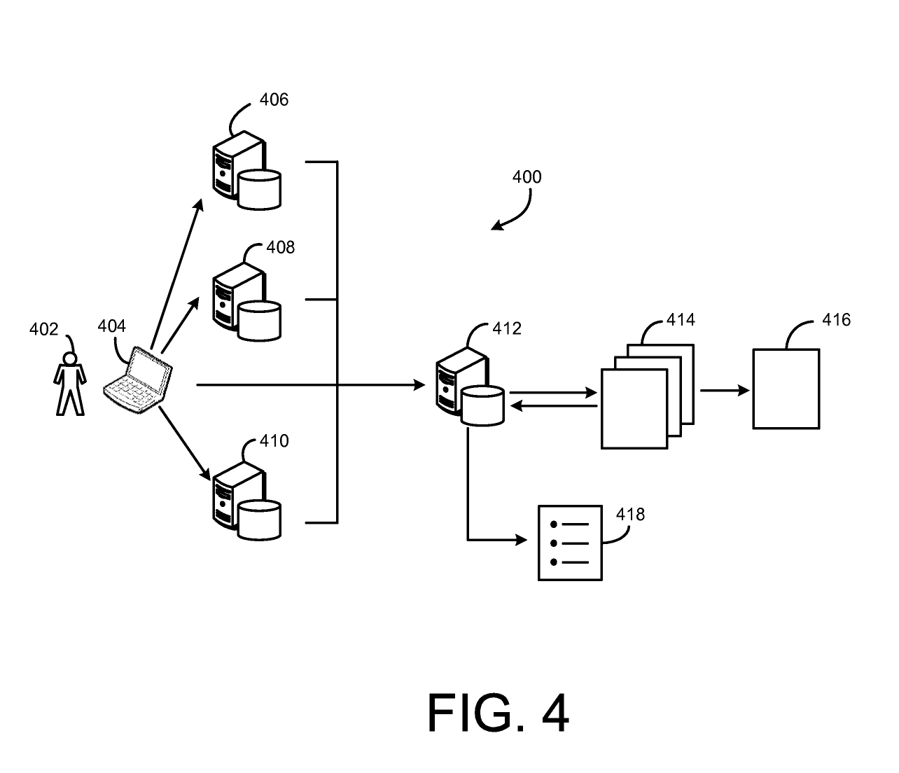

FIG. 4 is a use case diagram depicting aspects of an example user interaction in accordance with at least one embodiment. In illustrative example 400, a user 402 is able to access a network, such as the Internet, via a user device 404. In illustrative example 400, the user 402 is able to access multiple network retailers 406, 408, and 410. The user 402 may be able to browse and select various items stored in an item catalog or database maintained by the network retailer 406. In accordance with at least one embodiment, the service provider 412 may also act as a network retailer, and the user may browse and select items available from an item catalog maintained by the service provider 412. Service provider 412 is an example of service provider 206 of FIG. 2.

A network retailer 406 may be external to the service provider 412. In accordance with at least one embodiment in which an external network retailer 406 requires an active account or login information, the service provider 412 may maintain an account with the external network retailer 406. In accordance with at least one embodiment in which an external network retailer 406 requires an active account or login information, the service provider 412 may create an account on behalf of the 402 using information stored by the service provider 412. In accordance with at least one embodiment, the service provider 412 may order items from the network retailer 406 to a fulfillment center, which may then be forwarded to the user 402. In accordance with at least one embodiment, the service provider 412 may place the order using payment information provided by the user 402 and have the item shipped directly to the user 402.

Once the user 402 has selected at least one item offering from an network retailer 406, the user 402 may request to be provided with a checkout page. The checkout page may be accessed via an icon on a browser interface, or it may be accessed when a user directs the browser to a site maintained by the service provider (such as by entering the uniform resource locator of the site). The user 402 may be required to sign in to an account prior to being provided with the checkout page. In accordance with at least one embodiment, the checkout page may include an aggregated list of items selected by the user 402. Once at least one item offering has been selected, procurement policies 414 may be enforced. These procurement policies may be enforced before the user 402 has been provided with a checkout page or they may be enforced upon a submission of a purchase request. For example, the user 402 may be prohibited from selecting items that s/he is not authorized to purchase or an icon that would typically be used to add the item to a shopping cart may be grayed out or otherwise inactivated. The procurement policies 414 may also be enforced when the user 402 attempts to complete a sales transaction.

When the user 402 has satisfied each of the procurement policies 414, a purchase order 416 may be generated. At any stage, the service provider 412 may generate a report 418, which details the purchases by a particular user 402, made from a particular network retailer 406, over a certain threshold, or any other suitable purchase information. The report 418 may be generated automatically or on-demand.

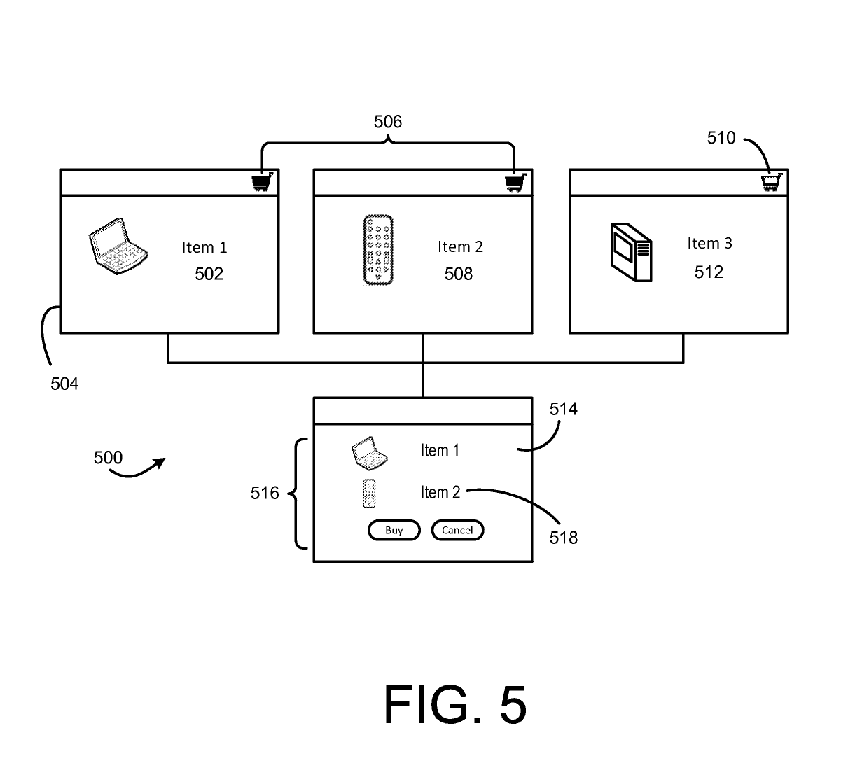

FIG. 5 is a user interface diagram depicting aspects of an example item selection in accordance with at least one embodiment. In illustrative example 500, a first item offering 502 is presented in a browser 504. In accordance with at least one embodiment, an active icon 506 may indicate that the capabilities of a browser 504 have been extended by a browser extension. An active icon 506 may also indicate that the currently viewed item offering, such as the first item offering 502 or the second item offering 504, can be purchased using the service provider. Upon selecting the active icon 506, the service provider may receive an indication of the item offering being viewed. In accordance with at least one embodiment, the service provider may receive network site information, such as a link, bookmark, or information stored within a cookie related to the item offering page. In accordance with at least one embodiment, the service provider may receive an identifier of the network retailer and an identifier of the item. For example, the service provider may receive an indication that the user is interested in “item 15243” available from www.businesssupplies.com.

In accordance with at least one embodiment, an inactive icon 510 may be presented. An inactive icon 510 may indicate that the currently viewed item offering, such as the third item offering 512 is unavailable via the service provider. In accordance with at least one embodiment, an item offering may be unavailable because the user has not met requirements set out by the procurement policies 414. In accordance with at least one embodiment, the service provider may not have an affiliation or purchasing relationship established with the network retailer providing the item. In accordance with at least one embodiment, interacting with an inactive icon 510 may submit a request to the service provider that it establish a purchasing relationship with the network retailer.

An example checkout page 514 is also illustrated in example 500. In accordance with at least one embodiment, a checkout page 514 may contain an aggregated list of item offerings 516. The aggregated list of item offerings 516 may contain information related to item offerings 518, such as a title, description, measurements, price, or any suitable item information. Once the user is satisfied with the aggregated list of item offerings 516, s/he may elect to submit a purchase request. In accordance with at least one embodiment, procurement policies 414 are applied upon submission of a purchase request.

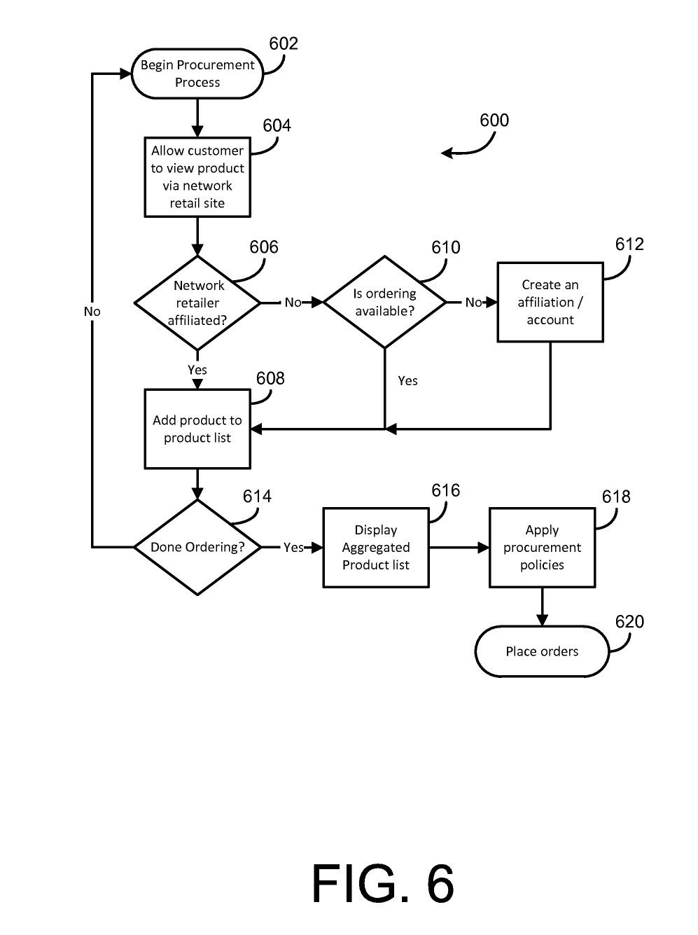

FIG. 6 is a flowchart depicting aspects of an example method for implementing procurement policies in accordance with at least one embodiment. Some or all of the process 600 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. In accordance with at least one embodiment, the process 600 of FIG. 6 may be performed by at least the one or more service providers 206 shown in FIG. 2. The code may be stored on a computer-readable storage medium, for example, in the form of a computer program including a plurality of instructions executable by one or more processors. The computer-readable storage medium may be non-transitory.

The process 600 may begin at 602 when a user logs in, visits a network retail site maintained by the service provider, or begins browsing an item catalog at a network retail site maintained by a network retailer. In process 600, the user may elect to view an item offering from the network retail site at 604. In accordance with at least one embodiment, a user is able to activate a browser extension by selecting an icon at 606. Upon selecting the icon, a determination must be made as to whether there is an affiliation between the network retailer providing the item and the service provider. If an affiliation does exist, then the item offering may be appended to an aggregated item list at 608. However, if there is no current affiliation between the service provider 206 and the network retailer, then the service provider may need to determine if an affiliation or account is required to order the item at 610. If no affiliation or account is necessary to place an order, then the service provider may add the item to the aggregated item list.

If an affiliation or user account is required in order to place a purchase with a network retail site, then the service provider may attempt to create the affiliation or user account at 612. In accordance with at least one embodiment, the service provider may create and maintain an account with the external network retailer on its own behalf. For example, the service provider may create an account with the network retail site that it uses to place orders for each of its users. In accordance with at least one embodiment, the service provider may create an account on behalf of the user that it uses to place orders on behalf of a particular user. In accordance with at least one embodiment, the user is able to request that the service provider establish a relationship with the network retail site. In accordance with at least one embodiment, a technician may manually place the purchase request for the user. Once an account or affiliation is created between the network retail site and the service provider, the item offering may be appended to the aggregated item list.

Once an aggregated item list has been generated, a user is given the opportunity to checkout or complete the process at 614. The user may elect to continue selecting items. In accordance with at least one embodiment, once the user has chosen to check out, the aggregated item list may be displayed at 616. In accordance with at least one embodiment, the aggregated item list may also contain additional data related to each item offering.

In accordance with at least one embodiment, before the transaction can be completed, procurement policies may be applied to the transaction at 618. In this step, each item involved in the transaction may be checked against procurement policies. In accordance with at least one embodiment, there may be user specific, role specific, or business entity specific procurement policies that apply to the transaction. Based on these procurement policies, some items may be removed from the aggregated item list, disallowed, or submitted to an authorization process. Once the procurement policies have been applied to the transaction, orders are placed for each of the approved items from each network retailer involved in the transaction at 620.

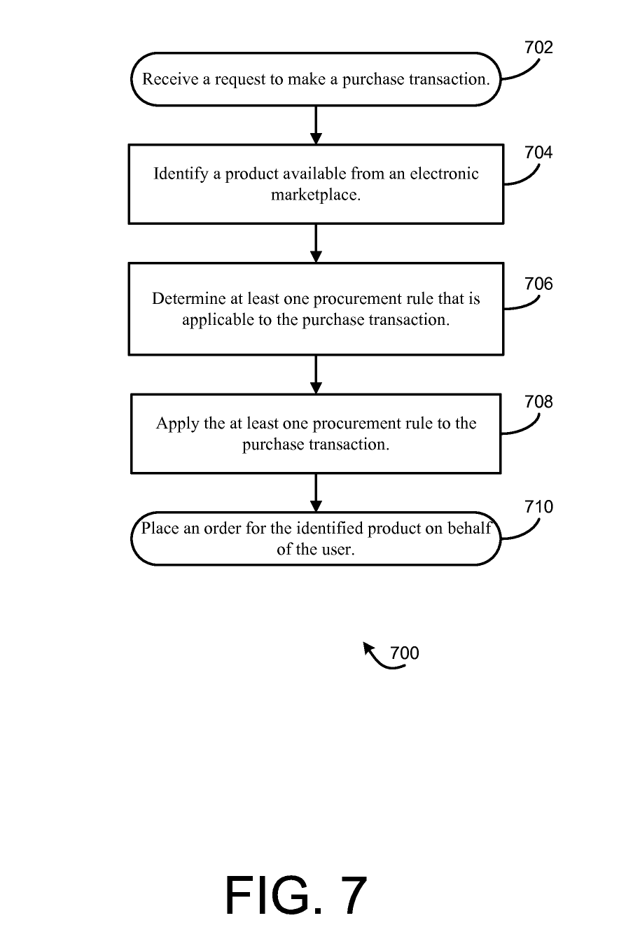

FIG. 7 is a flowchart depicting aspects of an example method for completing a purchase transaction in accordance with at least one embodiment. Some or all of the process 700 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. In accordance with at least one embodiment, the process 700 of FIG. 7 may be performed by at least the one or more service providers 206 shown in FIG. 2. The code may be stored on a computer-readable storage medium, for example, in the form of a computer program including a plurality of instructions executable by one or more processors. The computer-readable storage medium may be non-transitory.

The process 700 may begin at 702 when a user logs in, visits a network site maintained by the service provider, or begins browsing an item catalog maintained by an network retailer and selects at least one item to be purchased in a purchase transaction. The item to be purchased may be identified at 704. In accordance with at least one embodiment, a uniform resource locator or network page link may be sent to the service provider 206 that identifies the item to be purchased. In accordance with at least one embodiment, when the user selects an item, a browser cookie may be placed on the user machine that indicates the item selected. In accordance with at least one embodiment, the user may select multiple items from a variety of network retailers. In these embodiments, the items may be combined into an aggregated list of items that is displayed to the user on a checkout page.

The service provider 206 may then determine at least one rule from a set of procurement rules that should be applied to the purchase transaction at 706. This rule may be determined as being applicable based on the item being purchased, the user making the purchase, a business entity (e.g., business entity 307 of FIG. 3.) to which the user belongs, a method of payment being used, or any other relevant factor. Once one or more rules are determined to be applicable to the purchase transaction, the rule is applied at 708.

A set of rules may be stored in a database, a text document, a markup language document (such as extensible markup language (XML)), or any other suitable storage method. For example, a rule set that is stored in an XML document may have the format:

```
<ABC_Corp>
      <limit>
      $1000
      </limit>
      <ProcurementAgent>
            <approval>
            $500
            </approval>
      </ProcurementAgent>
</ABC_Corp>
```

In this example, the rule set may be applied to the business entity ABC Corp. Furthermore, this example pertains to two rules, one that is applied to all ABC Corp. employees, and one that is applied to a specific job role (procurement agent) within that business entity. In this example, an employee of ABC Corp. is not able to spend more than $1000. Furthermore, a procurement agent employed by the business entity ABC Corp. would need approval for any transaction over $500 in addition to being subject to the $1000 limit. In applying a rule to a transaction, the conditions related to the transaction are evaluated in light of the rule. If a trigger condition, or one that indicates that a rule is to be applied, is satisfied, then the rule associated with that trigger condition may be applied to the transaction. An action may be associated with each rule. For example, the limit rule may be associated with a “deny” action, so that if all of the trigger conditions of the limit rule are met, the transaction is denied. To illustrate by using the example above, if a procurement agent attempts to purchase a $600 item, then the trigger condition for the approval rule is satisfied but the trigger condition for the limit rule is not. In that scenario, the approval rule will stop the transaction until the procurement agent's manager (or other authorized entity) approves the transaction. By way of further example, the application of the approval rule may result in a purchase order being forwarded to a second user for authorization.

Procurement policies may be stored by the service provider after being selected and/or provided by a business entity. In accordance with at least one embodiment, default procurement policies may be provided by the service provider. For example, the service provider may provide a default procurement workflow upon the creation of a new account for a business entity. Furthermore, the business entity may be given the ability to create, alter, remove, and/or add workflows, procurement activities and/or procurement rules that are stored as part of the procurement policy data. In accordance with at least one embodiment, a business entity may upload and/or provide a set of procurement policies in a markup language document (e.g., an XML document) to the service provider, which the service provider may then parse and map to a suitable corresponding data structure. In accordance with at least one embodiment, a business entity may set procurement policies via a graphical user interface (GUI) maintained by the service provider. Procurement policies selected and/or edited via the graphical user interface may then be translated to and stored in one or more suitable formats by the service provider 206.

In accordance with at least one embodiment, a comparison (e.g., pricing information for multiple items) may be provided to an authorizing party. For example, if a procurement agent for ABC Corp in the example above attempts to purchase an item from vendor 1 for $600, authorization may be sought from a supervisor. In this example, the supervisor may also be provided with a notice that the same item (or an equivalent) being purchased for $600 from vendor 1 is available from vendor 2 for $500. Although this example focuses on allowing the authorizing party to make a comparison based on price, the comparison may be based on any number of factors, such as merchant rating, geographic location, merchant reliability, or any other suitable factor. The authorizing party may further be given the ability to switch the third party seller of the item from vendor 1 to vendor 2. In accordance with at least one embodiment, order details other than the seller of the item remain the same and the procurement agent has no further interaction with the transaction.

Once the procurement rule has been applied to the purchase transaction, an order is placed on the user's behalf at 710. To do this, the service provider 206 may create an account with an unaffiliated network retailer. The account may be created using on behalf of the user by providing information related to the user. The account may be created on behalf of the service provider 206 so that the actual customer is not exposed to the network retailer.

The various embodiments further can be implemented in a wide variety of operating environments, which in some cases can include one or more user computers, computing devices or processing devices which can be used to operate any of a number of applications. User or client devices can include any of a number of personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response requests from user device, such as by executing one or more Web applications that may be implemented as one or more scripts or programs written in any programming language, such as JAVA®, C, C# or C++, or any scripting language, such as Perl, Python or TCL, as well as combinations thereof. The server(s) may also include database servers, including without limitation those commercially available from Oracle Corporation, Microsoft Corporation SAP AG and International Business Machines Corporation

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A computer-implemented method comprising:
under control of a first computing device associated with a service provider, the first computing device executing specific computer-executable instructions,
receiving, from a second computing device, a request related to procurement of an item on behalf of a business entity,
wherein the request:
identifies an offering for the item from a network retail site, the offering presented by the second computing device to a user via a browser application implemented by the second computing device,
is associated with the user, and
is generated by an extension to the browser application,
wherein the user is associated with the business entity, and
wherein the business entity is distinct from the service provider;
in response to the request, identifying from a plurality of procurement policies maintained by the service provider in an electronic data store, a procurement policy that is relevant to the procurement of the item,
wherein the identifying is based at least in part on an attribute of the user, and
wherein the plurality of procurement policies is maintained by the service provider in the electronic data store on behalf of a variety of business entities;
determining that the procurement policy provides for procurement of the item on behalf of the business entity; and
initiating a purchase transaction for the item from the network retail site on behalf of the business entity in accordance with the procurement policy.

2. The computer-implemented method of claim 1, wherein the user is required to log into a user account associated with the service provider, and wherein the procurement policy is identified from the plurality of procurement policies based at least in part on the attribute of the user and an association between the procurement policy and the user account.

3. The computer-implemented method of claim 1, wherein the network retail site is not affiliated with the service provider.

4. The computer-implemented method of claim 3, wherein the request comprises at least one of a cookie identifying the offering for the item, a hyperlink identifying the offering for the item, a bookmark identifying the offering for the item, or a uniform resource identifier identifying the offering for the item.

5. A system comprising:
a data store configured to store specific computer-executable instructions; and
a first computing device in communication with the data store, the first computing device including a processor configured to execute the specific computer-executable instructions to at least:
receive, from a second computing device implementing a browser application, a request for a transaction for an item, the transaction to be conducted on behalf of a business entity, the request generated in response to an interaction by a user with an extension to the browser application, the browser application presenting information related to the item on the second computing device;
identify the item from the request;
identify from a plurality of procurement policies, a procurement policy associated with the business entity that is applicable to the transaction for the item, the procurement policy identified from the plurality of procurement policies based at least in part on an attribute of the user;
determining, based at least in part on the procurement policy associated with the business entity, that the transaction for the item can be conducted; and
initiate conducting of the transaction for the item on behalf of the business entity.

6. The system of claim 5, wherein the procurement policy is identified from the plurality of procurement policies based at least in part on at least one of: the business entity, the user, a method of payment, or a category of the item.

7. The system of claim 5, wherein the procurement policy comprises a rule related to at least one of: a maximum transaction amount, a minimum transaction amount, a type of payment method that must be used, a role of the user within the business entity, an authorization needed prior to completing the transaction, or a category of the item.

8. The system of claim 5, wherein the request comprises at least one of a cookie, a hyperlink, a bookmark, or a uniform resource identifier.

9. The system of claim 5, wherein the request identifies a network site from which the item is available for acquisition.

10. The system of claim 9, wherein initiating the purchase transaction comprises causing a checkout page to be presented by the browser application on the second computing device, the checkout page associated with a service provider distinct from a provider of the network site from which the item is available for acquisition.

11. The system of claim 5, wherein the processor is further configured to execute the specific computer-executable instructions to at least implement a procurement workflow in order to conduct the transaction for the item on behalf of the business entity.

12. A non-transitory computer readable storage memory device storing specific computer-executable instructions that, when executed by a processor, cause a computer system to at least:
receive, from a computing device implementing a browser, a first request with respect to procurement of a first item, the first request generated in response to an interaction by a user with an extension to the browser as the browser presents a first network page from a first network site referencing the first item;
identify the first item from the first request; and
identify a procurement rule for the item from a plurality of procurement rules stored in a data store maintained by a service provider that is distinct from a provider of the first network site, the procurement rule associated with at least one of the user or the entity.

13. The non-transitory computer readable storage memory device of claim 12, wherein the instructions, when executed with a processor, further cause the computer system to at least:
receive, from the computing device implementing the browser, a second request with respect to procurement of a second item, the second request generated in response to an interaction by the user with the extension to the browser as the browser presents a second network page referencing the second item from a second network site;
identify the second item from the second request; and
initiate procurement of the first item and the second item in accordance with the procurement rule.

14. The non-transitory computer readable storage memory device of claim 12, wherein an icon is presented by the browser to indicate that the extension is active.

15. The non-transitory computer readable storage memory device of claim 12, wherein the request comprises at least one of a cookie, a hyperlink, a bookmark, or a uniform resource identifier.

16. The non-transitory computer readable storage memory device of claim 12, wherein the specific computer-executable instructions, when executed with a processor, further cause the computer system to at least initiate procurement of the first item in accordance with the procurement rule.

17. The non-transitory computer readable storage memory device of claim 12, wherein procurement of the first item is initiated using information provided by the procurement rule.

18. The non-transitory computer readable storage memory device of claim 17, wherein the user is unable to alter the information provided by the procurement rule.

19. A non-transitory computer readable storage memory device storing a browser extension module, wherein the browser extension module, when executed by a processor of a user computing device, causes the user computing device to at least:
present an icon on the user computing device as a browser utilizing the browser extension module presents a network page from a network site, the network page referencing an item;
generate a request to procure the item on behalf of an entity, the request generated in response to an interaction by a user with the icon;
transmit the request to a service provider computing system that maintains a data store of a plurality of procurement policies, wherein a provider of the service provider computing system is distinct from a provider of the network site, and wherein the service provider computing system is configured to at least identify a procurement policy associated with the entity from the data store based at least in part on an attribute of the user;
receive, from the service provider computing system, an indication that the procurement policy identified by the service provider computing system does not provide for the item to be procured from the network site; and
inactivate the icon.

20. The non-transitory computer readable storage memory device of claim 19, wherein interaction by the user with the icon after it is inactivated causes the browser extension module, when executed by a processor of a user computing device, to further cause the user computing device to at least:
generate a request to establish a relationship between the provider of the service provider computing system and the provider of the network site so that the item can be procured from the network site; and
transmit the request to establish the relationship to the service provider computing system.

21. The non-transitory computer readable storage memory device of claim 19, wherein the request comprises at least one of a cookie, a hyperlink, a bookmark, or a uniform resource identifier.
